(19) United States
(12) Patent Application Publication
(10) Pub. No.: US 2026/0067750 A1
(43) Pub. Date: Mar. 5, 2026

(54) WIRELESS TRANSMITTER, WIRELESS RECEIVER, WIRELESS RELAY, CONTROL CIRCUIT, STORAGE MEDIUM, COMMUNICATION SYSTEM, AND COMMUNICATION METHOD

(71) Applicant: Mitsubishi Electric Corporation, Tokyo (JP)

(72) Inventor: Yasunori NODA, Tokyo (JP)

(73) Assignee: Mitsubishi Electric Corporation, Tokyo (JP)

(21) Appl. No.: 19/386,667

(22) Filed: Nov. 12, 2025

Related U.S. Application Data
(63) Continuation of application No. PCT/JP2023/021912, filed on Jun. 13, 2023.

(51) Int. Cl. H04W 28/06; H04B 1/40

(52) U.S. Cl. CPC H04W 28/06; H04B 1/40

(57) ABSTRACT

A wireless transmitter includes: wired reception units that each receive a wired signal transmitted by wire and including a plurality of frames; a wireless control signal applying unit that inserts a wireless control signal, which is a control signal for wireless communication management, in an interval in which no information transmission is performed between the frames of the wired signal received; and a wireless signal generation unit that generates a wireless signal to be wirelessly transmitted by using a received bit pattern of the wired signal and the wireless control signal.

### CROSS-REFERENCE TO RELATED APPLICATION

This application is a continuation application of International Application PCT/JP2023/021912, filed on Jun. 13, 2023, and designating the U.S., the entire contents of which are incorporated herein by reference.

### BACKGROUND OF THE INVENTION

### 1. Field of the Invention

The present disclosure relates to a wireless transmitter, a wireless receiver, a wireless relay, a control circuit, a storage medium, a communication system, and a communication method for making wired communication partially wireless.

### 2. Description of the Related Art

Various techniques are known for making wired communication wireless. Depending on requirements and conditions required for wireless, a frequency band and a medium to be used need to be selected appropriately. For example, Japanese Patent Application Laid-open No. 2018-014716 discloses a technique of converting a wired signal into a millimeter-wave signal and wirelessly transmitting the millimeter-wave signal. Millimeter waves having high linearity of propagation are less likely to interfere with other communication and can easily secure a wide band, thereby being suitable for high-capacity, low-latency wireless transmission.

However, the above conventional technique only discloses re-modulating the wired signal into a wireless bit pattern and transmitting the wireless bit pattern, and has a problem that, in a wireless transmission section, communication management such as measurement of communication quality or adjustment of a communication rate cannot be performed.

The present disclosure has been made in view of the above, and an object thereof is to provide a wireless transmitter that enables communication management in a wireless transmission section obtained by making wired communication partially wireless.

### SUMMARY OF THE INVENTION

In order to solve the above-described problems and achieve the object, a wireless transmitter according to the present disclosure includes: a wired reception unit to receive a wired signal transmitted by wire and including a plurality of frames, a wireless control signal applying unit to insert a wireless control signal, which is a control signal for wireless communication management, in an interval in which no information transmission is performed between the frames of the wired signal received, and a wireless signal generation unit to generate a wireless signal to be wirelessly transmitted by using a received bit pattern of the wired signal and the wireless control signal.

### BRIEF DESCRIPTION OF THE DRAWINGS

FIG. 1 is a diagram illustrating a functional configuration of a wireless transmitter according to a first embodiment;

FIG. 2 is a diagram illustrating a wired signal received by the wireless transmitter and a wireless signal transmitted by the wireless transmitter when an Ethernet frame is used;

FIG. 3 is a diagram illustrating a functional configuration of a wireless receiver according to the first embodiment;

FIG. 4 is a diagram illustrating an exemplary configuration of a communication system including the wireless transmitter and the wireless receiver;

FIG. 5 is a diagram illustrating an exemplary configuration of a communication system including the wireless transmitter, the wireless receiver, and a wireless relay;

FIG. 6 is a diagram illustrating a functional configuration of the wireless relay according to a second embodiment;

FIG. 7 is a diagram illustrating an exemplary configuration of a communication system including communication devices with a bidirectional communication function; and

FIG. 8 is a diagram illustrating an example of a hardware configuration.

### DETAILED DESCRIPTION OF THE PREFERRED EMBODIMENTS

Hereinafter, a wireless transmitter, a wireless receiver, a wireless relay, a control circuit, a storage medium, a communication system, and a communication method according to embodiments of the present disclosure will be described in detail with reference to the drawings.

### First Embodiment

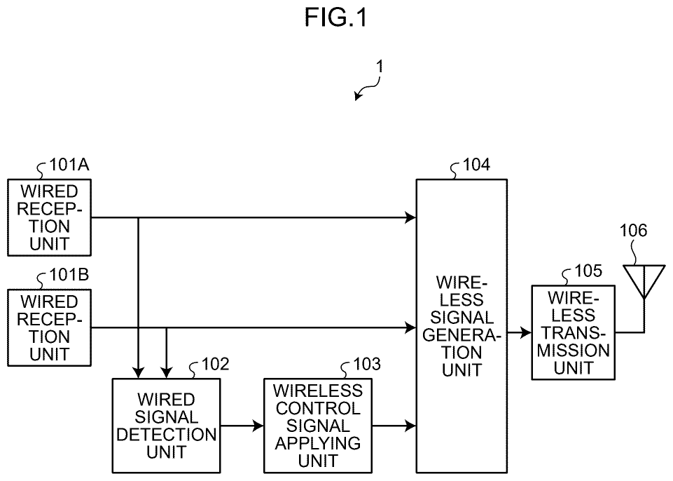

FIG. 1 is a diagram illustrating a functional configuration of a wireless transmitter 1 according to a first embodiment. The wireless transmitter 1 is an example of a communication device having a function of receiving a wired signal that is a signal transmitted by wire and a function of converting the wired signal into a wireless signal and wirelessly transmitting the wireless signal.

The wireless transmitter 1 includes wired reception units 101A and 101B, a wired signal detection unit 102, a wireless control signal applying unit 103, a wireless signal generation unit 104, a wireless transmission unit 105, and a transmitting antenna unit 106. Note that the wired reception units 101A and 101B perform similar processing and thus may be hereinafter simply referred to as a wired reception unit 101 in a case where the wired reception unit 101A and the wired reception unit 101B do not particularly need to be distinguished from each other. Note that a signal line of a wired signal received by the wired reception unit 101A is referred to as a signal line #A, and a signal line of a wired signal received by the wired reception unit 101B is referred to as a signal line #B.

The wired reception unit 101 receives the wired signal. The wired reception unit 101 performs wired communication according to a communication scheme such as Ethernet (registered trademark), RS-232C, RS-422, or RS-485. Each of these communication schemes performs, as wired communication, burst transmission in which a frame is treated as one block. The wired reception unit 101 generates demodulated data of the wired signal received, and outputs a bit string of the demodulated data generated to each of the wired signal detection unit 102 and the wireless signal generation unit 104.

The wired signal detection unit 102 detects an interval in which no information transmission is performed between frames of the wired signal received by the wired reception unit 101. The wired signal detection unit 102 outputs information indicating the detected interval to the wireless control signal applying unit 103.

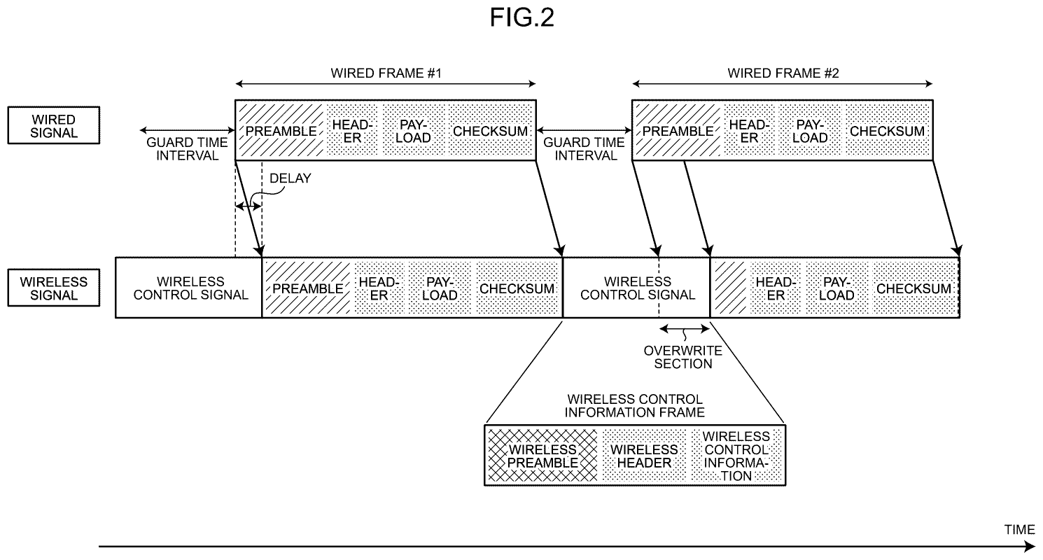

FIG. 2 is a diagram illustrating the wired signal received by the wireless transmitter 1 and a wireless signal transmitted by the wireless transmitter 1 when an Ethernet frame is used. The wired signal received by the wireless transmitter 1 includes a plurality of wired frames. Each of the wired frames can include a preamble, a header, a payload, and a checksum. Here, the wired frame is the Ethernet frame. In the case of Ethernet, the presence of the Ethernet frame is recognized using, as a mark, a predetermined bit pattern called a start frame delimiter (SFD), which exists in the preamble or the header received following the preamble, and an operation of decoding the payload in the Ethernet frame and passing data of the payload to an upper layer is performed. The Ethernet frame constitutes one burst. Between the frames, there is a guard time interval called an inter packet gap (IPG) or an inter frame gap (IFG). Although no significant Ethernet frame exists in this interval, a synchronization signal between transmission and reception may be transmitted in a wired physical layer. In a general Ethernet PHY module, only the Ethernet frame portion excluding the guard time interval or the synchronization signal is passed to a function in charge of a media access control (MAC) layer, so that from the MAC layer, the guard time interval is determined as an interval with no signal, that is, an interval in which no information transmission is performed.

In addition, in RS-232C, a cluster of data framed by a start bit and a stop bit is transmitted as one burst, and an interval from the stop bit to the next start bit is the guard time interval in which no information transmission is performed.

The wired signal detection unit 102 outputs, to the wireless control signal applying unit 103, information indicating the interval in which no information transmission is performed between the frames of the wired signal as described above. The “information indicating the interval in which no information transmission is performed between the frames of the wired signal” may be, for example, information indicating a section with a wired burst, and a section other than the section with the wired burst may be determined as the “interval in which no information transmission is performed between the frames of the wired signal”.

The wireless control signal applying unit 103 inserts, in the interval in which no information transmission is performed between the frames of the wired signal, a wireless control signal that is a control signal for wireless communication. The wireless control signal includes one or more wireless control information frames. As illustrated in FIG. 2, the wireless control information frame includes a wireless preamble, a wireless header, and wireless control information. Note that, although “the wireless control signal is inserted in the interval in which no information transmission is performed”, in a case where the wired signal is a signal including a long preamble as in the Ethernet frame and including, in the header, information indicating a start position of a frame body such as the SFD, a part of the preamble of the wired frame may be overwritten with the wireless control signal as illustrated in FIG. 2. The wireless signal includes the information included in the wired frame of the wired signal and the wireless control signal where, in the example illustrated in FIG. 2, a part of the preamble of the wired frame #2 is overwritten with the wireless control signal. In this case, the wireless control signal longer than the guard time interval by the length of the overwrite section can be transmitted. In the case where a part of the preamble of the wired frame is overwritten with the wireless control signal, the valid wired signal can be restored by reassigning the preamble to the top when the SFD is received on the receiving side.

The wireless signal generation unit 104 uses a received bit pattern of the wired signal received by the wired reception unit 101 and the wireless control signal inserted by the wireless control signal applying unit 103, thereby generating the wireless signal to be wirelessly transmitted by the wireless transmission unit 105. The wireless signal generation unit 104 outputs the wireless signal generated to the wireless transmission unit 105.

The wireless transmission unit 105 wirelessly transmits the wireless signal generated by the wireless signal generation unit 104 via the transmitting antenna unit 106. As a result, the wireless transmitter 1 transmits the wireless signal in which, as illustrated in FIG. 2, the wireless control signal is inserted in the interval in which no information transmission is performed between the wired frames of the wired signal.

The Ethernet frame often has an error detection function called a frame check sequence (FCS) based on a cyclic redundancy check (CRC). However, when converting the wired signal into the wireless signal, the wireless transmitter 1 does not necessarily need to perform the CRC check to remove a frame in which an error is detected. This is because an amount of delay increases if all the frames are received until the CRC calculation is completed, and then the frames are transmitted to a subsequent stage after being determined to be transmitted or not transmitted. The CRC check need only be performed by a communication device that performs upper layer processing, and a device such as the wireless transmitter 1 that relays and transfers the Ethernet frame or the like equivalently as it is need not execute error detection.

An example of the wireless control information included in the wireless control signal includes a known sequence for channel estimation necessary for coherent detection of binary phase shift keying (BPSK) or the like. Thus, if the receiving side can correct an amount of phase rotation of the known sequence, coherent detection can be implemented, which also makes it possible to implement signal multiplexing based on quadrature phase shift keying (QPSK) or spreading codes described later. Furthermore, when the known sequence is transmitted as the wireless control information, a signal level and a noise level can be measured on the basis of a received result of the known sequence, and adaptive modulation using a modulation scheme corresponding to a reception environment can also be used. For example, in a case where a received signal-to-noise ratio (SNR) is lower than a threshold, a modulation scheme that is resistant to noise, such as BPSK or binary ASK, may be used, or in a case where the received SNR exceeds the threshold, multi-level transmission may be performed. In this case, as the wireless control information, a transmission parameter of the modulation scheme or the like can be stored.

The wireless control information frame can include the aforementioned known sequence, transmission parameter, and the like as the wireless control information. The wireless control information frame can include information serving as a mark indicating that the frame is dedicated to wireless control, a type of control information, and a control information body. At this time, in a case where an application for transmitting and receiving the original wired frame is oriented to minimize a transmission delay of the wired frame, when a next wired frame arrives during the transmission of the wireless control information, the transmission of the frame of the wireless control information needs to be interrupted halfway in order to avoid a loss of the information of the wired frame, whereby it is preferable to configure the frame size of the wireless control information to be as small as possible. If a sufficient delay is allowed, the loss of the wireless control information frame can be avoided, but there is a trade-off relationship between the amount of delay and the frame size of the wireless control information frame, so that in a case where the wireless control information frame is transmitted in a time division manner as illustrated in FIG. 2, it is required to either secure the frame size of the wireless control information frame by adding a delay or allow interruption of the reception of the wireless control information frame in order to prevent an increase in the delay.

The wireless control information frame is desirably a frame in a form different from that of the wired frame. However, in a case where a duty ratio of the wired signal is low and the reception of the wireless control information frame is less likely to be interrupted halfway even when a large frame size is secured for the wireless control information frame, the wireless control information frame may be a frame in a form such as that of the Ethernet frame having a long preamble and header as with the wired frame. For example, in a case where the Ethernet frame is transmitted by wire with a time occupancy of the wired frame known to be not high in a system, such as in a case where the rate of Ethernet is known to be up to 100 Mbps while wireless communication has transmission capability of 1 Gbps, it is considered that the duty ratio of the wired signal is low. When the header portion enables identification of whether information is the information included in the original wired frame or the information added at the time of conversion into the wireless signal, it is also possible to make a selection on the receiving side and output only the information included in the wired frame. Also, in a case where the duty ratio of the wired signal is expected to be high, a data block having a small header such as 64b/66b can be set as one wireless control information frame. In addition to the above examples, the wireless control information frame can have any configuration as long as the information included in the wired signal can be identified on the receiving side.

Note that a plurality of signal lines received by the wireless transmitter 1 may be processed in parallel by the wired signal detection unit 102 and the wireless control signal applying unit 103, and the wireless signal generation unit 104 may multiplex the plurality of signal lines. In the example of FIG. 1, the wireless transmitter 1 receives the signal line #A and the signal line #B, so that the wired signal detection unit 102 and the wireless control signal applying unit 103 can process the signal line #A and the signal line #B in parallel, and the wireless signal generation unit 104 can multiplex the signal line #A and the signal line #B. In the case of multiplexing the plurality of signal lines, the wireless transmission rate needs to be higher than or equal to a sum of the transmission rates of the wired connections. As a multiplexing method, in the case of multiplexing two signal lines, a transmission scheme that obtains orthogonal channels such as QPSK can be used to map sequences of the signal lines on a real axis and an imaginary axis. In the case of multiplexing two or more signal lines, a scheme such as 64 quadrature amplitude modulation (QAM) can be used in which a plurality of bits is allocated to each of the real axis and the imaginary axis. In 64 QAM, three bits can be allocated to each of the real axis and the imaginary axis, so that up to six signal lines can be accommodated. Moreover, a multiplexing scheme based on spreading using orthogonal codes can be used to multiplex the plurality of signal lines. An example of the scheme using the spreading codes includes a method of using Walsh codes having good cross-correlation characteristics. When the plurality of signal lines is multiplexed using the aforementioned QPSK, 64 QAM, spreading codes, or the like, transmission can be performed while preventing or reducing delay jitter of the signal lines.

Furthermore, as another method of multiplexing the plurality of signal lines, as in parallel to serial (P/S) conversion, the signal line to be allocated is switched and mapped for each wireless modulation symbol or bit. In this case, as with multiplexing by spreading, it is necessary to have an environment in which the wireless transmission rate is sufficiently high. In the case of performing P/S conversion, data needs to be supplied even in an interval in which there is no information to be transmitted by a specific signal line, but, as described above, when the wireless control signal is inserted in the interval in which no information transmission is performed by the wired signal, the interval in which no information transmission is performed can be eliminated so that the receiving side can correctly restore the original signal sequence.

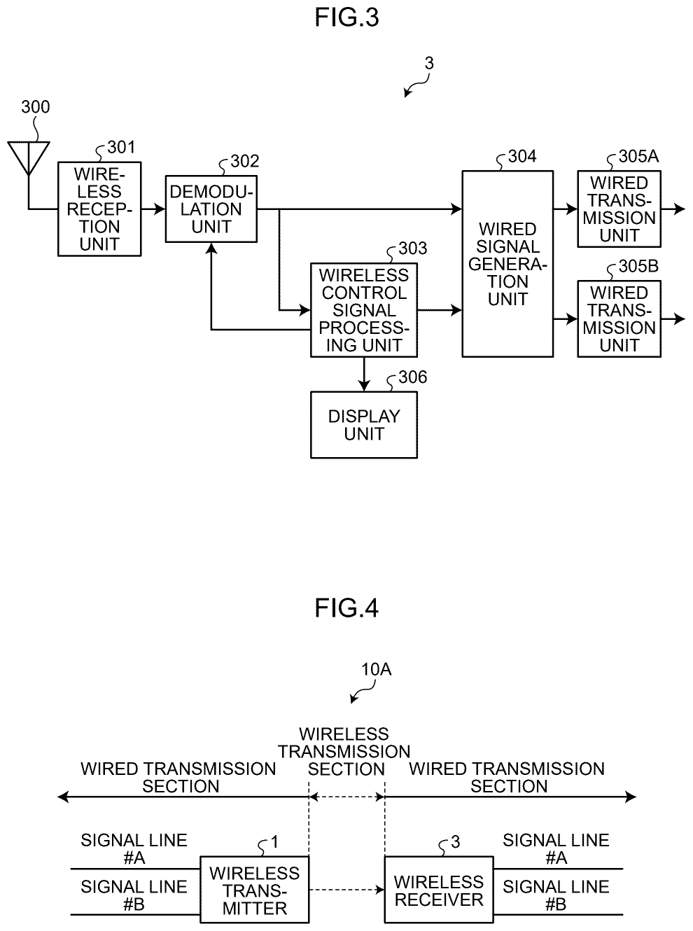

FIG. 3 is a diagram illustrating a functional configuration of a wireless receiver 3 according to the first embodiment. The wireless receiver 3 is an example of a communication device having a function of receiving the wireless signal transmitted by the wireless transmitter 1, converting the wireless signal received into a wired signal, and transmitting the wired signal.

The wireless receiver 3 includes a receiving antenna unit 300, a wireless reception unit 301, a demodulation unit 302, a wireless control signal processing unit 303, a wired signal generation unit 304, wired transmission units 305A and 305B, and a display unit 306.

The wireless reception unit 301 receives the wireless signal, which is radiated into the air as a radio wave by the wireless transmitter 1, using the receiving antenna unit 300 and outputs the wireless signal as a received signal to the demodulation unit 302.

The demodulation unit 302 performs, on the received signal, demodulation processing corresponding to the modulation scheme used on the transmitting side, and outputs a bit string of the demodulation result to each of the wired signal generation unit 304 and the wireless control signal processing unit 303. In a case where the modulation scheme is fixed, the demodulation unit 302 uses a fixed demodulation scheme to perform the demodulation processing, thereby being able to correctly demodulate data included in the received signal.

In a case where the modulation scheme is variable, the modulation scheme used on the transmitting side is stored in the wireless control signal, but the modulation scheme is unknown until the wireless control signal processing unit 303 decodes the modulation scheme stored in the wireless control signal. Thus, for example, only the modulation scheme of the wireless control signal can be fixed. In this case, the demodulation unit 302 performs, on the wireless control signal, demodulation processing corresponding to a predetermined modulation scheme, decodes the modulation scheme for the signal sequence included in the wired frame, and performs demodulation processing corresponding to the modulation scheme decoded. Moreover, the number of candidates for the modulation scheme of the wireless control signal can be limited to about two. In this case, the demodulation unit 302 may, for example, perform demodulation processings corresponding to respective predetermined candidates for the modulation scheme, attempt to decode demodulation results, and adopt the demodulation result from which the header has been read.

The wireless control signal processing unit 303 can perform processing based on the wireless control signal. For example, in a case where the wireless control signal includes a known pilot signal, the wireless control signal processing unit 303 can measure communication quality using the pilot signal received. Moreover, in a BPSK modulation system, in a case where the wireless control signal includes a known sequence for channel estimation, the wireless control signal processing unit 303 observes an amount of phase rotation of the known sequence and applies feedback to a down-converter of the demodulation unit 302, thereby being able to implement a coherent detection function including phase tracking such as that of a phase locked loop (PLL). In addition, the wireless control signal processing unit 303 can use a known signal included in the wireless control signal to measure the SNR and handle the SNR as an indicator of communication quality. Also, the wireless control signal processing unit 303 can perform error detection from a demodulation result of the known signal included in the wireless control signal and handle an error detection result as an indicator of communication quality. For example, in a case where the wireless control signal processing unit 303 determines that reception of a plurality of frames has failed consecutively, the wireless control signal processing unit 303 can use the display unit 306 to display communication error information. The display unit 306 may be a display such as a light emitting diode (LED) or an interface that outputs information to an external device such as a serial console. The display unit 306 may display an FCS result of not only the wireless control signal but also the wired frame. In this case, the wireless control signal processing unit 303 also reads the wired frame included in the data obtained from the demodulation unit 302 and executes FCS.

The wired signal generation unit 304 extracts the original wired frame obtained by removing the wireless control signal from the received signal, and generates the wired signal that is a signal to be transmitted by wire. The wired signal generation unit 304 outputs the wired signal generated to one of the wired transmission units 305A and 305B. The wired transmission unit 305A as an output destination of the wired signal generation unit 304 corresponds to the wired reception unit 101A of the wireless transmitter 1, and the wired transmission unit 305B corresponds to the wired reception unit 101B of the wireless transmitter 1. That is, the wired transmission unit 305A corresponds to the signal line #A, and the wired transmission unit 305B corresponds to the signal line #B. From the viewpoint of wired transmission sections, without being conscious of a wireless transmission path interposed in between, the wired reception unit 101A and the wired transmission unit 305A can be treated as if they are directly connected, and the wired reception unit 101B and the wired transmission unit 305B can be treated as if they are directly connected. The wired signal generation unit 304 can select the output destination of the received signal from the wired transmission units 305A and 305B on the basis of, for example, address information included in the Ethernet frame. In a communication scheme in which the address information cannot be assigned, such as in RS-232C or the like, the wireless control signal processing unit 303 outputs information that enables determination of the output destination of each signal sequence to the wired signal generation unit 304, so that the wired signal generation unit 304 can select the output destination of the wired signal generated. Note that, in a case where the preamble of the original wired signal is overwritten when the wireless control signal is inserted, the wired signal generation unit 304 can restore the original wired signal by reassigning the preamble that is a predetermined sequence on the basis of the position of the SFD.

Note that in the wireless transmitter 1 illustrated in FIG. 1 and the wireless receiver 3 illustrated in FIG. 3, the number of signal lines transmitted by wire is two, but the number of signal lines may be one or three or more.

FIG. 4 is a diagram illustrating an exemplary configuration of a communication system 10A including the wireless transmitter 1 and the wireless receiver 3. The communication system 10A includes one unit of the wireless transmitter 1 and one unit of the wireless receiver 3 that receives the wireless signal transmitted by the wireless transmitter 1. The wireless transmitter 1 converts the wired signal into the wireless signal and wirelessly transmits the wireless signal, and the wireless receiver 3 receives the wireless signal, converts the wireless signal into the wired signal, and transmits the wired signal by wire. At this time, the wireless transmitter 1 inserts the wireless control signal, which is the control signal for wireless communication, in the interval in which no information transmission is performed between the plurality of frames included in the wired signal, so that it is possible to transmit the wireless control information for performing various types of control in the wireless transmission section to the wireless receiver 3. The wireless receiver 3 removes the wireless control signal from the received signal to restore the original wired signal, that is, the wired signal received by the wireless transmitter 1, and transmits the wired signal by wire.

Although not illustrated in FIG. 4 for simplicity, in the wired transmission section, a plurality of devices including a source device and a destination device of the wired signal of each signal line is connected. As described above, the wired signal transmitted in the wired transmission section does not change before and after the wireless transmission section, so that the devices connected in the wired transmission section can operate without being conscious of the presence of the wireless transmission section, that is, operate as in a case where the devices are connected not wirelessly but by wire in the wireless transmission section.

As described above, the wireless transmitter 1 according to the first embodiment includes: the wired reception units 101A and 101B that each receive the wired signal transmitted by wire and including the plurality of the frames; the wireless control signal applying unit 103 that inserts the wireless control signal, which is the control signal for wireless communication management, in the interval in which no information transmission is performed between the frames of the wired signal received; and the wireless signal generation unit 104 that generates the wireless signal to be wirelessly transmitted by using the received bit pattern of the wired signal and the wireless control signal. With such a configuration, the wireless transmitter 1 having received the wired signal transmits the wireless signal obtained by inserting the wireless control signal, which is the control signal for wireless communication management, in the interval in which no information transmission is performed between the frames of the wired signal, thereby being able to perform wireless communication management in the wireless transmission section, which is obtained by making wired communication partially wireless, by using the wireless control signal in the wireless transmission section. The wireless communication management refers to grasping a communication environment such as communication quality of the wireless transmission section and adjusting a parameter related to wireless communication such as the communication rate. As a result, it is possible to monitor a wireless communication environment externally, isolate causes and check a communication status when a communication failure occurs, and flexibly provide various communication functions such as adjustment of the transmission rate and signal multiplexing by providing means for selecting a wireless transmission mode depending on the communication quality.

Here, the wireless signal generation unit 104 overwrites the preamble included in the frame with the wireless control signal to be able to generate the wireless signal including the wireless control signal longer than the interval in which no information transmission is performed between the frames of the wired signal.

Moreover, in the wireless transmitter 1, even in a case where the wired signal includes an error detection code, error detection processing need not be executed. As a result, the occurrence of delay jitter can be prevented or reduced, and thus low latency, low delay jitter, and communication quality can all be achieved easily.

Moreover, the wireless transmitter 1 includes the plurality of the wired reception units 101A and 101B corresponding to respective ones of the plurality of the signal lines, and one unit of the wireless transmission unit 105 that transmits the wireless signal, where the wireless signal generation unit 104 can generate the wireless signal by multiplexing the plurality of the signal lines, and one unit of the wireless transmission unit 105 can perform multiplexed transmission of the plurality of the signal lines. In the wired communication, one wiring is required for each signal line, whereas in the wireless transmitter 1, the plurality of the signal lines can be transmitted and received by the single antenna. At this time, with the use of a channel in which interference between the signal lines is controlled, even when the plurality of the signal lines is simultaneously transmitted and received by the single antenna, the communication quality can be maintained by preventing or reducing the influence of the interference.

The frames constituting the wired signal may be the Ethernet frames.

Moreover, according to the first embodiment, the wireless receiver 3 that receives the wireless signal transmitted by the wireless transmitter 1 described above can include the wireless control signal processing unit 303 that performs wireless communication management in the wireless transmission section of the wireless signal on the basis of the wireless control signal included in the wireless signal. As a result, on the basis of the wireless control signal inserted on the transmitting side, the receiving side can perform the wireless communication management in the wireless transmission section. For example, the wireless control signal processing unit 303 can perform, as the wireless communication management, at least either measurement of the wireless communication quality in the wireless transmission section or operation control of reception processing of the wireless signal transmitted by the wireless transmitter 1.

The wireless receiver 3 can further include the wired signal generation unit 304 that removes the wireless control signal from the wireless signal received and restores the wired signal received by the wireless transmitter 1, and the wired transmission units 305A and 305B that transmit, by wire, the wired signal restored. As a result, the wired signal received by the wireless transmitter 1 and the wired signal transmitted by the wireless receiver 3 are the same, so that the source device and the destination device of the wired communication can perform communication in a procedure similar to that in a case where the communication path between the source device and the destination device is connected entirely by wire without recognizing that a part of the communication path is connected wirelessly.

Note that, as described above, the wireless transmitter 1 may overwrite the preamble portion of the frame, but in a case where the wired signal generation unit 304 of the wireless receiver 3 cannot detect the preamble of the predetermined bit pattern in the portion of the frame for information transmission of the wireless signal received, the wired signal is restored by reassigning the preamble. Therefore, even in the case where the wireless transmitter 1 overwrites the preamble portion of the frame with the wireless control signal, the original wired signal can be reliably restored.

Moreover, the functions of the wireless transmitter 1 according to the first embodiment can be implemented using a control circuit as described later. This control circuit is a control circuit for controlling the wireless transmitter 1 that receives the wired signal transmitted by wire and including the plurality of the frames, converts the wired signal into the wireless signal, and transmits the wireless signal, and can cause the wireless transmitter 1 to execute a step of inserting the wireless control signal, which is the control signal for wireless communication management, in the interval in which no information transmission is performed between the frames of the wired signal received.

Moreover, a storage medium can be provided for implementing the functions of the wireless transmitter 1 according to the first embodiment. This storage medium is a storage medium storing a program for controlling the wireless transmitter 1 that receives the wired signal transmitted by wire and including the plurality of the frames, converts the wired signal into the wireless signal, and transmits the wireless signal, and the program can cause the wireless transmitter 1 to execute a step of inserting the wireless control signal, which is the control signal for wireless communication, in the interval in which no information transmission is performed between the frames of the wired signal received.

Furthermore, the communication system 10A according to the first embodiment makes wired communication partially wireless and includes: the wireless transmitter 1 that receives the wired signal transmitted by wire and including the plurality of the frames, generates the wireless signal by inserting the wireless control signal, which is the control signal for wireless communication, in the interval in which no information transmission is performed between the frames of the wired signal received, and transmits the wireless signal generated; and the wireless receiver 3 that receives the wireless signal transmitted by the wireless transmitter 1, performs wireless communication management in the wireless transmission section of the wireless signal on the basis of the wireless control signal included in the wireless signal received, removes the wireless control signal from the wireless signal received, restores the wired signal received by the wireless transmitter 1, and transmits by wire the wired signal restored.

Moreover, according to the first embodiment, a communication method can be provided for making wired communication partially wireless. This communication method includes: a step in which the wireless transmitter 1 receives the wired signal transmitted by wire and including the plurality of the frames; a step in which the wireless transmitter 1 generates the wireless signal by inserting the wireless control signal, which is the control signal for wireless communication, in the interval in which no information transmission is performed between the frames of the wired signal received; a step in which the wireless transmitter 1 transmits the wireless signal generated; a step in which the wireless receiver 3 receives the wireless signal; a step in which the wireless receiver 3 performs wireless communication management in the wireless transmission section of the wireless signal on the basis of the wireless control signal included in the wireless signal received; a step in which the wireless receiver 3 removes the wireless control signal from the wireless signal received and restores the wired signal received by the wireless transmitter 1; and a step in which the wireless receiver 3 transmits by wire the wired signal restored.

### Second Embodiment

In FIG. 4, the wireless signal transmitted by the wireless transmitter 1 is directly transmitted to the wireless receiver 3, but the wireless signal may be transmitted via a wireless relay 4.

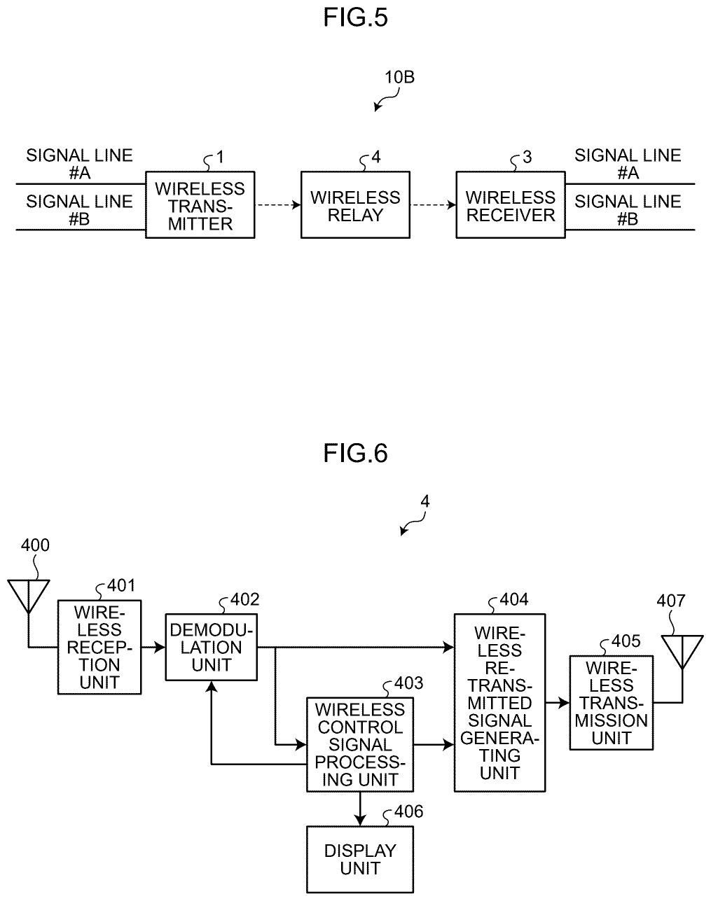

FIG. 5 is a diagram illustrating an exemplary configuration of a communication system 10B including the wireless transmitter 1, the wireless receiver 3, and the wireless relay 4. Note that, here, the communication system 10B including one unit of the wireless relay4 is illustrated, but the wireless signal transmitted by the wireless transmitter 1 may be relayed in series by two units of the wireless relays 4 and transmitted to the wireless receiver 3.

FIG. 6 is a diagram illustrating a functional configuration of the wireless relay 4 according to the second embodiment. The wireless relay 4 includes a receiving antenna unit 400, a wireless reception unit 401, a demodulation unit 402, a wireless control signal processing unit 403, a wireless re-transmitted signal generating unit 404, a wireless transmission unit 405, a display unit 406, and a transmitting antenna unit 407.

The receiving antenna unit 400 has a function similar to that of the receiving antenna unit 300. The wireless reception unit 401 has a function similar to that of the wireless reception unit 301. The demodulation unit 402 has a function similar to that of the demodulation unit 302. The display unit 406 has a function similar to that of the display unit 306.

The wireless control signal processing unit 403 has, in addition to the function of the wireless control signal processing unit 303, a function of generating a wireless control signal of a signal, which is transmitted as a relay signal, by a method similar to that of the wireless control signal applying unit 103 and outputting the wireless control signal generated to the wireless re-transmitted signal generating unit 404 as a bit string. The wireless control signal generated by the wireless control signal processing unit 403 may be the same as the wireless control signal received or may be, for example, the wireless control signal obtained by adding, to the wireless control signal received, information such as a relay count indicating which hop of the relay it is. Moreover, in a case where there is a possibility of interference with another relay link, a control signal different from that of a previous link may be transmitted by selecting a different sequence having good orthogonality with respect to the signal of the previous link as a pilot signal.

The wireless re-transmitted signal generating unit 404 generates a wireless re-transmitted signal, which is a signal re-transmitted as the relay signal, on the basis of a received bit pattern of the wireless signal output from the demodulation unit 402 and a bit sequence of the wireless control signal output from the wireless control signal processing unit 403, and outputs the wireless re-transmitted signal generated to the wireless transmission unit 405.

The wireless transmission unit 405 has a function similar to that of the wireless transmission unit 105, and transmits the wireless re-transmitted signal output from the wireless re-transmitted signal generating unit 404 by using the transmitting antenna unit 407. The transmitting antenna unit 407 has a function similar to that of the transmitting antenna unit 106.

Note that although the wireless relay 4 illustrated in FIG. 6 has both the function of receiving the wireless signal and the function of transmitting the wireless signal, the wireless relay 4 need not be implemented as one device by accommodating all the functions thereof in one housing. For example, the demodulation function on the receiving side and the signal generation function on the transmitting side may be implemented in physically separated places. For example, the demodulation unit 402 and the wireless re-transmitted signal generating unit 404 may be connected by a cable of about several meters. Note that not only the connection between the demodulation unit 402 and the wireless re-transmitted signal generating unit 404 but also the connection between any ones of the other components may be similarly connected by a cable of about several meters. This can achieve an effect that communication performance is easily secured by combining the wired connection more resistant to electromagnetic noise than the wireless connection.

As described above, the wireless relay 4 according to the second embodiment is the wireless relay 4 that relays the wireless signal transmitted by the wireless transmitter 1, and can include the wireless re-transmitted signal generating unit 404 that generates the wireless re-transmitted signal as the wireless signal to be re-transmitted on the basis of the wireless signal received, and the wireless transmission unit 405 that transmits the wireless re-transmitted signal.

The wireless relay 4 further includes the wireless control signal processing unit 403 that generates the wireless control signal of the wireless re-transmitted signal by adding the information of the relay count to the wireless control signal included in the wireless signal received, and the wireless re-transmitted signal generating unit 404 generates the wireless re-transmitted signal including the wireless control signal generated by the wireless control signal processing unit 403.

Using the wireless relay 4 can extend a wireless transmission distance of the wireless signal which is generated by converting the wired signal and in which the wireless control signal is inserted.

Note that, in the above description, the wireless transmitter 1 having the function of transmitting the wireless signal and the wireless receiver 3 having the function of receiving the wireless signal are separate devices, but one communication device 6 may have the functions of both the wireless transmitter 1 and the wireless receiver 3.

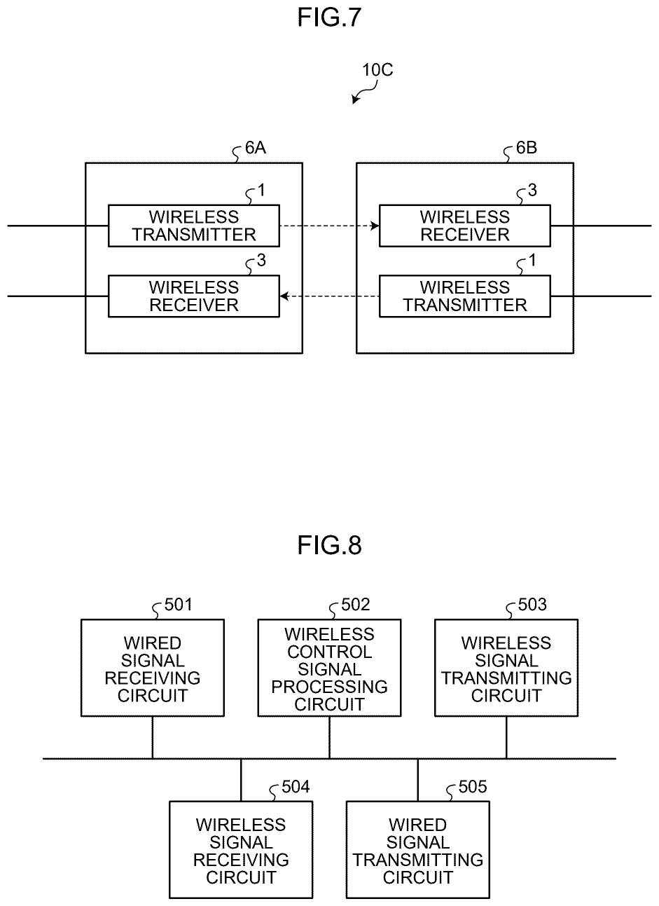

FIG. 7 is a diagram illustrating an exemplary configuration of a communication system 10C including communication devices 6A and 6B with a bidirectional communication function. Note that, here, two units of the communication devices 6 with the bidirectional communication function are referred to as the communication devices 6A and 6B to be distinguished from each other. The communication system 10C includes the communication device 6A and the communication device 6B.

The communication devices 6A and 6B each include the wireless transmitter 1 and the wireless receiver 3. Since the functions of the wireless transmitter 1 are similar to those described with reference to FIG. 1, the description thereof is omitted here. Likewise, since the functions of the wireless receiver 3 are similar to those described with reference to FIG. 3, the description thereof is omitted here. The wireless transmitter 1 of the communication device 6A converts the wired signal into the wireless signal and wirelessly transmits the wireless signal, and the wireless receiver 3 of the communication device 6B receives the wireless signal. The wireless receiver 3 of the communication device 6B can perform various wireless control processes on the basis of a demodulation result of the wireless control signal included in the wireless signal received. Similarly, the wireless transmitter 1 of the communication device 6B converts the wired signal into the wireless signal and wirelessly transmits the wireless signal, and the wireless receiver 3 of the communication device 6A receives the wireless signal. The wireless receiver 3 of the communication device 6A can also perform various wireless control processes on the basis of a demodulation result of the wireless control signal included in the wireless signal received. As described above, when the communication devices 6A and 6B each including the wireless transmitter 1 and the wireless receiver 3 are used, bidirectional communication between two points as a part of the system connected by wire can be made wireless. Since the wireless control signal is included in the wireless signal between the communication device 6A and the communication device 6B, various wireless control processes can be implemented even when the wired communication is partially made wireless.

Now, a hardware configuration will be described. Here, an example of the hardware configuration of the communication device 6 having the bidirectional communication function will be described as an example. FIG. 8 is a diagram illustrating the example of the hardware configuration. The communication device 6 performs bidirectional communication by frequency division duplex (FDD) or time division duplex (TDD), and has the functions of both the wireless transmitter 1 and the wireless receiver 3.

The communication device 6 includes a wired signal receiving circuit 501, a wireless control signal processing circuit 502, a wireless signal transmitting circuit 503, a wireless signal receiving circuit 504, and a wired signal transmitting circuit 505.

The wired signal receiving circuit 501 has a function of receiving a wired signal and generating demodulated data. The wireless control signal processing circuit 502 has a function of applying a wireless control signal, processing the wireless control signal, and displaying communication quality. The wireless signal transmitting circuit 503 has a function of generating and modulating a wireless signal and converting the frequency into a wireless frequency. The wireless signal receiving circuit 504 has a function of converting the frequency of a wireless signal from a wireless frequency to a baseband or intermediate frequency and performing demodulation processing. The wired signal transmitting circuit 505 has a function of generating a wired signal and transmitting the wired signal generated. The aforementioned functional blocks are connected to one another.

Although the example of the hardware configuration of the communication device 6 having the bidirectional communication function has been described here, the wireless transmitter 1, the wireless receiver 3, and the wireless relay 4 can be configured by omitting some of the functional blocks.

The functions of the wired reception units 101A and 101B and the wired signal detection unit 102 are implemented by the wired signal receiving circuit 501. The function of the wireless control signal applying unit 103 is implemented by the wireless control signal processing circuit 502. The functions of the wireless signal generation unit 104 and the wireless transmission unit 105 are implemented by the wireless signal transmitting circuit 503. That is, the functions of the wireless transmitter 1 can be implemented by the wired signal receiving circuit 501, the wireless control signal processing circuit 502, and the wireless signal transmitting circuit 503.

In addition, the functions of the wireless reception unit 301 and the demodulation unit 302 are implemented by the wireless signal receiving circuit 504. The functions of the wireless control signal processing unit 303 and the display unit 306 are implemented by the wireless control signal processing circuit 502. The functions of the wired signal generation unit 304 and the wired transmission units 305A and 305B are implemented by the wired signal transmitting circuit 505. That is, the functions of the wireless receiver 3 can be implemented by the wireless signal receiving circuit 504, the wireless control signal processing circuit 502, and the wired signal transmitting circuit 505.

In addition, the functions of the wireless reception unit 401 and the demodulation unit 402 are implemented by the wireless signal receiving circuit 504. The functions of the wireless control signal processing unit 403 and the display unit 406 are implemented by the wireless control signal processing circuit 502. The functions of the wireless re-transmitted signal generating unit 404 and the wireless transmission unit 405 are implemented by the wireless signal transmitting circuit 503. That is, the functions of the wireless relay 4 can be implemented by the wireless signal receiving circuit 504, the wireless control signal processing circuit 502, and the wireless signal transmitting circuit 503.

Note that the wired signal receiving circuit 501, the wireless control signal processing circuit 502, the wireless signal transmitting circuit 503, the wireless signal receiving circuit 504, and the wired signal transmitting circuit 505 are each a processing circuit. These processing circuits may each be dedicated hardware or a control circuit using a central processing unit (CPU). When implemented by the dedicated hardware, the processing circuit is a single circuit, a complex circuit, a programmed processor, a parallel-programmed processor, an application specific integrated circuit (ASIC), a field programmable gate array (FPGA), or a combination thereof. When implemented by the control circuit using the CPU, the processing circuit includes the CPU and a memory, and the CPU reads and executes a program stored in the memory to implement the processing of each component. The CPU is also referred to as an arithmetic unit, a microprocessor, a microcomputer, a digital signal processor (DSP), or the like. The memory is, for example, a non-volatile or volatile semiconductor memory such as a random access memory (RAN), a read only memory (ROM), a flash memory, an erasable programmable ROM (EPROM), or an electrically EPROM (EEPROM (registered trademark)), a magnetic disk, a flexible disk, an optical disk, a compact disc, a mini disc, a digital versatile disc (DVD), or the like. The memory is also used as a temporary memory in each processing executed by the CPU. Note that the program executed by the CPU may be stored in a storage medium and provided, or may be provided via a network such as the Internet.

The wireless transmitter according to the present disclosure has an effect of enabling the communication management in the wireless transmission section obtained by making wired communication partially wireless.

The configurations illustrated in the above embodiments each merely illustrate an example so that another known technique can be combined, the embodiments can be combined together, or the configurations can be partially omitted and/or modified without departing from the scope of the present disclosure.

What is claimed is:

1. A wireless transmitter for wirelessly transmitting a section of a communication signal in wired communication between a source device and a destination device that are associated in advance on a one-to-one basis, the wireless transmitter comprising:
wired reception circuitry to receive a wired signal transmitted by wire and including a plurality of frames;
wireless control signal applying circuitry to insert a wireless control signal, which is a control signal for wireless communication management, in an interval in which no information transmission is performed between the frames of the wired signal received; and
wireless signal generation circuitry to generate a wireless signal to be wirelessly transmitted by using a received bit pattern of the wired signal and the wireless control signal, wherein
the wireless signal generation circuitry performs modulation processing by adaptive modulation using a modulation scheme corresponding to communication quality of a wireless transmission section of the wireless signal, and
the wireless control signal includes information indicating the modulation scheme used in the modulation processing.

2. The wireless transmitter according to claim 1, wherein the wireless signal generation circuitry overwrites a preamble included in the frame with the wireless control signal to generate the wireless signal including the wireless control signal longer than the interval in which no information transmission is performed between the frames of the wired signal.

3. The wireless transmitter according to claim 1, wherein, even in a case where the wired signal includes an error detection code, error detection processing is not executed.

4. A wireless transmitter comprising:
a plurality of wired reception circuits provided corresponding to respective ones of a plurality of signal lines to each receive a wired signal transmitted by wire and including a plurality of frames;
wireless control signal applying circuitry to insert a wireless control signal, which is a control signal for wireless communication management, in an interval in which no information transmission is performed between the frames of the wired signal received;
wireless signal generation circuitry to generate a wireless signal to be wirelessly transmitted by using a received bit pattern of the wired signal and the wireless control signal; and
one wireless transmission circuit to transmit the wireless signal, wherein
the wireless signal generation circuitry generates the wireless signal by multiplexing the plurality of signal lines, and
the one wireless transmission circuit performs multiplexed transmission of the plurality of signal lines.

5. The wireless transmitter according to claim 1, wherein the frame included in the wired signal is an Ethernet frame.

6. A wireless receiver that receives the wireless signal transmitted by the wireless transmitter according to claim 1, the wireless receiver comprising:
demodulation circuitry to perform demodulation processing on the wireless signal; and
wireless control signal processing circuitry to perform wireless communication management in the wireless transmission section on the basis of the wireless control signal included in the wireless signal, wherein
the demodulation circuitry performs the demodulation processing corresponding to a modulation scheme indicated by the wireless control signal.

7. The wireless receiver according to claim 6, wherein the wireless control signal processing circuitry performs, as the wireless communication management, at least one of measurement of wireless communication quality in the wireless transmission section or operation control of reception processing of the wireless signal transmitted by the wireless transmitter.

8. The wireless receiver according to claim 6, further comprising:
wired signal generation circuitry to remove the wireless control signal from the wireless signal received and restore the wired signal received by the wireless transmitter; and
wired transmission circuitry to transmit, by wire, the wired signal restored.

9. The wireless receiver according to claim 8, wherein, in a case where the wired signal generation circuitry cannot detect a predetermined preamble in a portion of the frame for information transmission of the wireless signal received, the wired signal generation circuitry restores the wired signal by reassigning the preamble.

10. A wireless relay that relays a wireless signal transmitted by a wireless transmitter for wirelessly transmitting a section of a communication signal in wired communication between a source device and a destination device that are associated in advance on a one-to-one basis, the wireless transmitter including:
wired reception circuitry to receive a wired signal transmitted by wire and including a plurality of frames;
wireless control signal applying circuitry to insert a wireless control signal, which is a control signal for wireless communication management, in an interval in which no information transmission is performed between the frames of the wired signal received; and
wireless signal generation circuitry to generate the wireless signal to be wirelessly transmitted by using a received bit pattern of the wired signal and the wireless control signal, wherein
the wireless relay comprises:
wireless control signal processing circuitry to perform wireless communication management in a wireless transmission section of the wireless signal on the basis of the wireless control signal included in the wireless signal received;
wireless re-transmitted signal generating circuitry to generate a wireless re-transmitted signal, which is a wireless signal to be re-transmitted, on the basis of the wireless signal received; and
wireless transmission circuitry to transmit the wireless re-transmitted signal.

11. The wireless relay according to claim 10, wherein
the wireless control signal processing circuitry generates a wireless control signal of the wireless re-transmitted signal by adding information of a relay count to the wireless control signal included in the wireless signal received, and
the wireless re-transmitted signal generating circuitry generates the wireless re-transmitted signal including the wireless control signal generated by the wireless control signal processing circuitry.

12. The wireless relay according to claim 10, wherein the wireless control signal processing circuitry performs, as the wireless communication management, at least one of measurement of wireless communication quality in the wireless transmission section or operation control of reception processing of the wireless signal transmitted by the wireless transmitter.

13. A control circuit that controls a wireless transmitter for wirelessly transmitting a section of a communication signal in wired communication between a source device and a destination device that are associated in advance on a one-to-one basis, the wireless transmitter receiving a wired signal transmitted by wire and including a plurality of frames, converting the wired signal into a wireless signal, and transmitting the wireless signal, wherein
the control circuit causes the wireless transmitter to execute,
inserting a wireless control signal, which is a control signal for wireless communication management, in an interval in which no information transmission is performed between the frames of the wired signal received, and
the wireless control signal includes information indicating a modulation scheme used in modulation processing performed by adaptive modulation, which uses the modulation scheme corresponding to communication quality of a wireless transmission section of the wireless signal, when the wireless transmitter generates the wireless signal.

14. A non-transitory storage medium storing a program for controlling a wireless transmitter for wirelessly transmitting a section of a communication signal in wired communication between a source device and a destination device that are associated in advance on a one-to-one basis, the wireless transmitter receiving a wired signal transmitted by wire and including a plurality of frames, converting the wired signal into a wireless signal, and transmitting the wireless signal, wherein
the program causes the wireless transmitter to execute,
inserting a wireless control signal, which is a control signal for wireless communication management, in an interval in which no information transmission is performed between the frames of the wired signal received, and
the wireless control signal includes information indicating a modulation scheme used in modulation processing performed by adaptive modulation, which uses the modulation scheme corresponding to communication quality of a wireless transmission section of the wireless signal, when the wireless transmitter generates the wireless signal.

15. A communication system that wirelessly transmits a section of a communication signal in wired communication between a source device and a destination device that are associated in advance on a one-to-one basis, the communication system comprising:
a wireless transmitter to receive a wired signal transmitted by wire and including a plurality of frames, generate a wireless signal by inserting a wireless control signal, which is a control signal for wireless communication management, in an interval in which no information transmission is performed between the frames of the wired signal received, and transmit the wireless signal generated; and
a wireless receiver to receive the wireless signal transmitted by the wireless transmitter, perform wireless communication management in a wireless transmission section of the wireless signal on the basis of the wireless control signal included in the wireless signal received, remove the wireless control signal from the wireless signal received, restore the wired signal received by the wireless transmitter, and transmit by wire the wired signal restored, wherein
the wireless transmitter performs modulation processing by adaptive modulation using a modulation scheme corresponding to communication quality of the wireless transmission section of the wireless signal,
the wireless control signal includes information indicating the modulation scheme used in the modulation processing, and
the wireless receiver performs demodulation processing corresponding to the modulation scheme indicated by the wireless control signal included in the wireless signal received.

16. A communication method of performing wireless transmission of a section of a communication signal in wired communication between a source device and a destination device that are associated in advance on a one-to-one basis, the communication method comprising:
receiving, by a wireless transmitter, a wired signal transmitted by wire and including a plurality of frames;
generating, by the wireless transmitter, a wireless signal by inserting a wireless control signal, which is a control signal for wireless communication management, in an interval in which no information transmission is performed between the frames of the wired signal received and performing, by the wireless transmitter, modulation processing by adaptive modulation using a modulation scheme corresponding to communication quality of the wireless transmission, the wireless control signal including information indicating the modulation scheme used in the modulation processing;
transmitting, by the wireless transmitter, the wireless signal generated;
receiving, by a wireless receiver, the wireless signal;
performing, by the wireless receiver, demodulation processing corresponding to the modulation scheme indicated by the wireless control signal included in the wireless signal received;
removing, by the wireless receiver, the wireless control signal from the wireless signal received and restoring, by the wireless receiver, the wired signal received by the wireless transmitter; and
transmitting by wire the wired signal restored, the transmitting being performed by the wireless receiver.
